(19) United States
(12) Patent Application Publication
(10) Pub. No.: US 2026/0282075 A1
(43) Pub. Date: Sep. 17, 2026

(54) DATA TRANSMISSION METHOD, AND BASE STATION, TERMINAL, DEVICE AND STORAGE MEDIUM

(71) Applicant: CHINA TELECOM CORPORATION LIMITED, Beijing (CN)

(72) Inventors: Nanxi LI, Beijing (CN); Jianchi ZHU, Beijing (CN); Jing GUO, Beijing (CN); Hang YIN, Beijing (CN); Xiaoming SHE, Beijing (CN)

(21) Appl. No.: 19/506,255

(22) PCT Filed: Jul. 22, 2022
(86) PCT No.: PCT/CN2022/107523

§ 371 Date: Jun. 2, 2026

(30) Foreign Application Priority Data
Jul. 30, 2021 (CN) 202110868865.X

(51) Int. Cl. H04W 74/00; H04W 72/0446; H04W 74/0833

(52) U.S. Cl. CPC H04W 74/004; H04W 72/0446; H04W 74/0833

(57) ABSTRACT

The present disclosure relates to the technical field of mobile communications. Provided are a data transmission method during a random access process, and a base station, a terminal, a device and a storage medium. The method comprises: receiving a random access preamble, which is sent by a user terminal; and sending a random access response to the user terminal, wherein the random access response comprises uplink grant information, the uplink grant information comprising configuration information of the number of repeated transmissions of Msg3, such that the user terminal determines the number of repeated transmissions of Msg3 according to the configuration information of the number of repeated transmissions of Msg3. By means of the method, the configuration of the number of repeated transmissions of Msg3 can be realized without adding additional signaling overheads, thereby improving the resource utilization rate.

### CROSS-REFERENCE TO RELATED APPLICATION

The present disclosure is a U.S. National Stage Application of International Application No. PCT/CN2022/107523, filed on Jul. 22, 2022, which is based upon and claims the priority to the Chinese Patent Application NO. 202110868865.X, entitled “DATA TRANSMISSION METHOD, BASE STATION, TERMINAL, DEVICE AND STORAGE MEDIUM”, filed on Jul. 30, 2021, the entire contents of both of which are hereby incorporated by reference.

### TECHNICAL FIELD

The present disclosure relates to the field of mobile communication technologies, and more particularly, to a data transmission method in a random access procedure, a base station, a terminal, a device, and a storage medium.

### BACKGROUND

The 3rd Generation Partnership Project (3GPP) New Radio (NR) Release-16 protocol does not support the Message 3 (Msg3) Physical Uplink Shared Channel (PUSCH) repetitions, and this feature is considered for introduction in the Release-17 coverage enhancement project to enhance uplink coverage performance. To enable the Msg3 repetitions, a base station needs to indicate the number of Msg3 repetitions to a user equipment. Before the initial transmission of the Msg3 PUSCH, the base station indicates the corresponding transmission resources through the Random Access Response (RAR) uplink (UL) grant information. In the relate arts, technologies of supporting the Msg3 repetitions are proposed, that is, a common Msg3 repetition parameter (such as Msg3-AggregationFactor) is configured on the initial uplink Bandwidth Part (BWP) or the Msg3 repetition parameter is indicated in Downlink Control Information (DCI) scheduling the Physical Downlink Shared Channel (PDSCH) corresponding to the RAR.

It should be noted that the information disclosed in the Background section above is only for enhancing the understanding of the background of the present disclosure, and thus may include information that does not constitute prior art known to those of ordinary skill in the art.

### SUMMARY

According to an aspect of the present disclosure, there is provided a data transmission method in a random access procedure, including: receiving a random access preamble transmitted by a user equipment; and transmitting a random access response to the user equipment, wherein the random access response includes uplink grant information; wherein the uplink grant information includes configuration information for the number of Msg3 repetitions, so that the number of Msg3 repetitions is determined by the user equipment according to the configuration information for the number of Msg3 repetitions.

According to another aspect of the present disclosure, there is provided a data transmission method in a random access procedure, including: transmitting, by a User Equipment (UE), a random access preamble; receiving, by the user equipment, a random access response from a network side, wherein the random access response includes uplink grant information, and the uplink grant information includes configuration information for the number of Msg3 repetitions; and determining, by the user equipment, the number of Msg3 repetitions according to the configuration information for the number of Msg3 repetitions in the uplink grant information in the random access response.

According to still another aspect of the present disclosure, there is provided a device, including: a memory, a processor, and executable instructions stored in the memory and executable in the processor, wherein the processor, when executing the executable instructions, implements any of the methods described above.

According to still another aspect of the present disclosure, there is provided a computer-readable storage medium having computer-executable instructions stored thereon, wherein the computer-executable instructions, when executed by a processor, implement any of the methods described above.

According to still another aspect of the present disclosure, there is provided a computer program product, including a computer program that, when executed by a processor, implements any of the methods described above.

It should be noted that the above general description and the following detailed description are merely exemplary and should not limit the present disclosure.

### BRIEF DESCRIPTION OF THE DRAWINGS

The above and other objectives, features and advantages of the present disclosure will become more apparent from a detailed description of example embodiments thereof with reference to the accompanying drawings.

FIG. 1 shows a diagram of contention-based random access signaling interactions in NR random access;

FIG. 2 shows a schematic diagram of a RAR format;

FIG. 3 shows a data transmission method in a random access procedure according to an embodiment of the present disclosure;

FIG. 4 shows a data transmission method in a random access procedure according to another embodiment of the present disclosure;

FIG. 5 shows a data transmission method in a random access procedure according to yet another embodiment of the present disclosure;

FIG. 6 shows a data transmission method in a random access procedure according to still another embodiment of the present disclosure;

FIG. 7 shows a data transmission method in a random access procedure according to still another embodiment of the present disclosure;

FIG. 8 shows a data transmission method in a random access procedure according to still another embodiment of the present disclosure;

FIG. 9 shows a data transmission method in a random access procedure according to still another embodiment of the present disclosure;

FIG. 10 shows a data transmission method in a random access procedure according to still another embodiment of the present disclosure;

FIG. 11 shows a data transmission method in a random access procedure according to still another embodiment of the present disclosure;

FIG. 12 shows a schematic structural diagram of a base station according to the present disclosure;

FIG. 13 shows a schematic structural diagram of a terminal according to the present disclosure; and

FIG. 14 shows a schematic structural diagram of a device according to the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The drawings are merely schematic representations of the present disclosure and are not necessarily drawn to scale. The same reference numerals in the drawings denote the same or similar parts, and the repeated description thereof will be omitted.

In addition, the features, structures, or characteristics described in the present disclosure may be combined in any suitable manner in one or more embodiments. In the following description, numerous specific details are set forth to provide a thorough understanding of the embodiments of the present disclosure. However, those skilled in the art will appreciate that the technical solution of the present disclosure may be practiced without one or more of the specific details, or other methods, apparatuses, steps and the like may be employed. In other instances, well-known structures, methods, apparatuses, implementations or operations are not shown or described in detail to avoid obscuring various aspects of the present disclosure.

Furthermore, the terms “first”, “second”, etc., are used for descriptive purposes only and should not be construed as indicating or implying relative importance or implicitly specifying the number of technical features indicated. Thus, a feature defined with “first” or “second” may explicitly or implicitly include one or more of that feature. In the description of the present disclosure, “multiple” or “a plurality of” means at least two, such as two, three, etc., unless otherwise explicitly specified. The symbol “/” generally indicates that the preceding and following associated objects are in an “or” relationship.

In the present disclosure, unless otherwise expressly specified and limited, the term “connection” and similar terms should be interpreted broadly, for example, it can refer to an electrical connection or the ability to communicate with each other; it can refer to a direct connection or an indirect connection through an intermediate medium. Those skilled in the art can understand the specific meaning of the above terms in the present disclosure according to the specific circumstances.

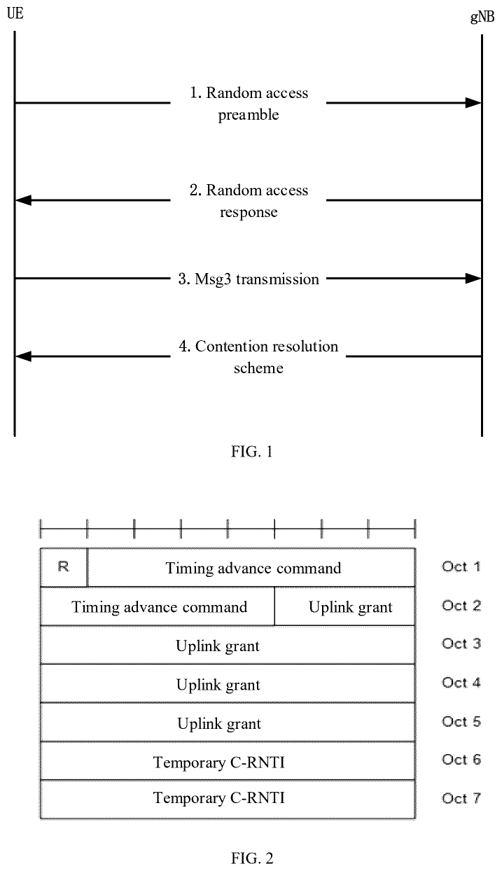

At present, random access procedures in NR can be divided into contention-based random access and contention-free random access. As shown in FIG. 1, the contention-based random access procedure is a four-step access procedure. FIG. 2 shows a schematic RAR format diagram according to an embodiment of the present disclosure, where the RAR includes uplink grant information.

During the initial transmission of Msg3 PUSCH, the base station indicates the corresponding transmission resource through the UL grant information of the random access response. In the relevant protocol, the RAR UL grant consists of 27 bits in total, as shown in the table below:

TABLE 1

| RAR uplink grant information | Number of bits |
|---|---|
| Frequency hopping flag | 1 |
| PUSCH frequency resource allocation | 14, for operation without shared |
| | spectrum channel access |
| | 12, for operation with shared |
| | spectrum channel access |
| PUSCH time resource allocation | 4 |
| Modulation and coding scheme (MCS) | 4 |
| Transmission Power Control (TPC) command for | 3 |
| PUSCH | |
| Channel State Information (CSI) Request | 1 |
| Channel Access-CPext | 0, for operation without shared |
| | spectrum channel access |
| | 2, for operation with shared spectrum |
| | channel access |

Those skilled in the art should understand that the RAR UL grant does not have additional padding bits or reserved bits for indicating the number of Msg3 repetitions. Changing the size of the RAR UL grant would lead to serious compatibility issues. Taking into account various aspects of existing protocols comprehensively, the inventors of the present disclosure provide a new technical solution for indicating the number of Msg3 repetitions through the RAR UL grant information, which can indicate the number of Msg3 repetitions, without changing the number of bits in the RAR UL grant.

In an implementation, the base station schedules the user equipment to perform Msg3 repetition, the base station transmits the corresponding Msg3 resource configuration information in the RAR UL grant, including configuration information for the number of Msg3 repetitions, and the user equipment performs the corresponding Msg3 repetition according to the configuration from the base station.

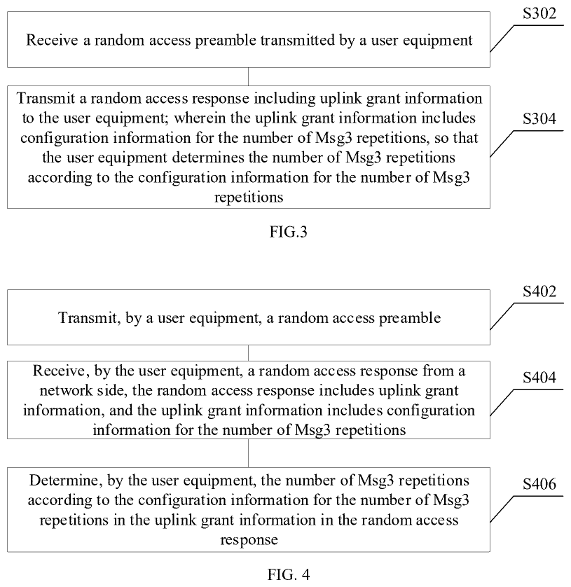

FIG. 3 shows a data transmission method in a random access procedure according to an embodiment of the present disclosure, which is applied to a base station or a network side.

As shown in FIG. 3, in step 302, the base station receives a random access preamble transmitted by a User Equipment (UE).

In step 304, the base station transmits a RAR including UL grant information to the UE, and the UL grant information includes configuration information for the number of Msg3 repetitions, so that the UE determines the number of Msg3 repetitions according to the configuration information for the number of Msg3 repetitions.

In the above embodiments, the configuration information for the number of Msg3 repetitions is carried in the UL grant information in the RAR, without changing the number of bits in the UL grant information, which achieves the maximum compatibility with the existing protocols, while improving resource utilization efficiency.

FIG. 4 shows a data transmission method in a random access procedure according to another embodiment of the present disclosure, which is applied to a user equipment.

As shown in FIG. 4, in step 402, the UE transmits a random access preamble to a base station.

In step 404, the UE receives a RAR including uplink grant information from the network side, and the UL grant information includes configuration information for the number of Msg3 repetitions.

In step 406, the UE determines the number of Msg3 repetitions according to the configuration information for the number of Msg3 repetitions in the UL grant information in the RAR.

In the above embodiments, the configuration information for the number of Msg3 repetitions is carried in the UL grant information in the RAR, without changing the number of bits in the UL grant information, which achieves the maximum compatibility with the existing protocols, while improving resource utilization efficiency.

In some embodiments, the configuration information for the number of Msg3 repetitions is indicated by a PUSCH time domain resource allocation field in the RAR UL grant information.

The PUSCH time domain resource allocation field in the RAR UL grant information includes four bits. Bit values in the field represent a specific index value, which corresponds to a set of information in a certain row in an uplink time domain resource allocation information indication table configured by System Information Block 1 (SIB1) or information in a certain row in an uplink time domain resource allocation information indication table predefined according to a protocol. In an embodiment, the configuration information for the number of Msg3 repetitions is added to a time domain resource allocation field, thereby enabling the indication of the number of Msg3 repetitions using the PUSCH time domain resource allocation information in the RAR UL grant information.

In an embodiment, there are two time domain resource allocation information indication tables. The first time domain resource allocation information indication table is an original time domain resource allocation information indication table, which does not include the number of Msg3 repetitions and is used for the UE that does not support the Msg3 repetition or the UE that is not scheduled by the base station to perform Msg3 repetition. The second time domain resource allocation information indication table is a newly added time domain resource allocation information indication table, which includes the number of Msg3 repetitions and is used for the UE that is scheduled by the base station to perform Msg3 repetition. The following table is an example of the second time domain resource allocation information indication table:

TABLE 2

| | | | Symbol | Number of |
|---|---|---|---|---|
| Row index | Slot offset | Start symbol | length | repetitions |
| 1 | j | 0 | 14 | 1 |
| 2 | j | 0 | 12 | 1 |
| 3 | j | 0 | 10 | 1 |
| 4 | j | 2 | 10 | 1 |
| 5 | j | 4 | 10 | 1 |
| 6 | j | 4 | 8 | 2 |
| 7 | j | 4 | 6 | 4 |
| 8 | j + 1 | 0 | 14 | 2 |
| 9 | j + 1 | 0 | 12 | 2 |
| 10 | j + 1 | 0 | 10 | 2 |
| 11 | j + 2 | 0 | 14 | 4 |
| 12 | j + 2 | 0 | 12 | 4 |
| 13 | j + 2 | 0 | 10 | 4 |
| 14 | j | 8 | 6 | 4 |
| 15 | j + 3 | 0 | 14 | 8 |
| 16 | j + 3 | 0 | 10 | 8 |

where j in the above table is defined as follows:

TABLE 3

| μ_{PUSCH} | j |
|---|---|
| 0 | 1 |
| 1 | 1 |
| 2 | 2 |
| 3 | 3 |

where μ_{PUSCH} represents the subcarrier spacing of Msg3, their specific relationship is as follows:

$$the subcarrier spacing of Msg 3 = 15 kHz * 2 \hat{} * ( {µ}_{PUSCH} ) \qquad ( 1 )$$

When μ_{PUSCH}=0, the subcarrier spacing of Msg3 is 15 kHz, and the corresponding j=1; and when μ_{PUSCH}=3, the subcarrier spacing of Msg3 is 120 kHz, and the corresponding j=3.

The base station can inform, in various manners, the user equipment whether to schedule this user equipment for the Msg3 repetition, thereby enabling the user equipment to determine whether to use the second (new) or the first (existing) time domain resource allocation information indication table. For example, the base station can implicitly or explicitly inform the user equipment which (the first or the second) time domain resource allocation information indication table to use.

In an embodiment, the base station implicitly informs the user equipment whether to schedule this user equipment for the Msg3 repetition: when the user equipment requests the Msg3 repetition, both the base station and the user equipment use the new time domain resource allocation information indication table; and when the user equipment does not request the Msg3 repetition, both the base station and the user equipment use the original time domain resource allocation information indication table. Those skilled in the art should understand that the user equipment not requesting the Msg3 repetition can include the user equipment lacking the capability to perform the Msg3 repetition, or the user equipment possessing the capability to perform the Msg3 repetition but not actively initiating the request for the Msg3 repetition. The following provides an embodiment in which the base station implicitly informs the user equipment whether to schedule this user equipment for the Msg3 repetition.

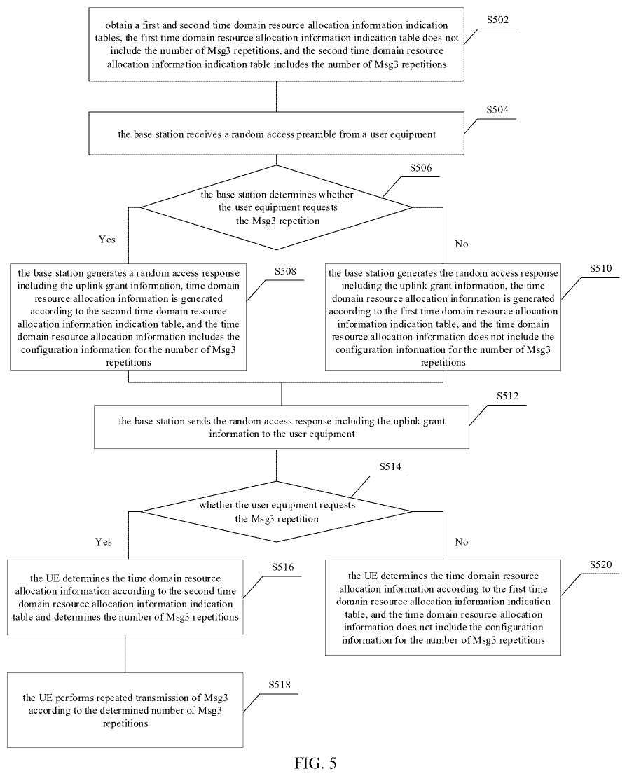

FIG. 5 shows a data transmission method in a random access procedure according to yet another embodiment of the present disclosure.

As shown in FIG. 5, in S502, the base station obtains a first time domain resource allocation information indication table and a second time domain resource allocation information indication table, the first time domain resource allocation information indication table does not include the number of Msg3 repetitions, and the second time domain resource allocation information indication table includes the number of Msg3 repetitions. The first and second time domain resource allocation information indication tables can be preset; alternatively, the first and second time domain resource allocation information indication tables are semi-statically configured through the Radio Resource Control (RRC).

In S504, the base station receives the random access preamble from the user equipment.

In S506, it is determined whether the user equipment requests the Msg3 repetition, if so, it continues to S508; otherwise, it continues to S510. For example, the base station can determine, according to the different time-frequency resource positions for the UE to transmit the PRACH or according to the different preambles, whether the user equipment requests the Msg3 repetition.

In S508, the base station generates a random access response including the uplink grant information, time domain resource allocation information in the UL grant information of the random access response is generated according to the second time domain resource allocation information indication table, and the time domain resource allocation information includes the configuration information for the number of Msg3 repetitions.

In S510, the base station generates the random access response including the uplink grant information, the time domain resource allocation information is generated according to the first time domain resource allocation information indication table, and the time domain resource allocation information does not include the configuration information for the number of Msg3 repetitions.

In S512, the base station transmits the random access response including the uplink grant information to the user equipment.

In S514, after receiving the random access response, the user equipment performs different subsequent processing depending on whether it requests the Msg3 repetition. If so, it continues to S516; otherwise, it continues to S520.

In S516, the user equipment determines the time domain resource allocation information according to the second time domain resource allocation information indication table and determines the number of Msg3 repetitions.

In S518, the user equipment performs Msg3 repetition according to the determined number of Msg3 repetitions, and then performs subsequent processing.

In S520, the user equipment determines the time domain resource allocation information according to the first time domain resource allocation information indication table, and the time domain resource allocation information does not include the configuration information for the number of Msg3 repetitions, and performs subsequent processing.

In the above embodiments, the base station implicitly determines whether to use the first time domain resource allocation information indication table or the second time domain resource allocation information indication table to generate the content of the time domain resource allocation field in the UL grant information in the random access response. The user equipment also implicitly determines whether to use the first time domain resource allocation information indication table or the second time domain resource allocation information indication table to parse the content of the time domain resource allocation field in the UL grant information, thereby saving signaling overhead and improving resource utilization.

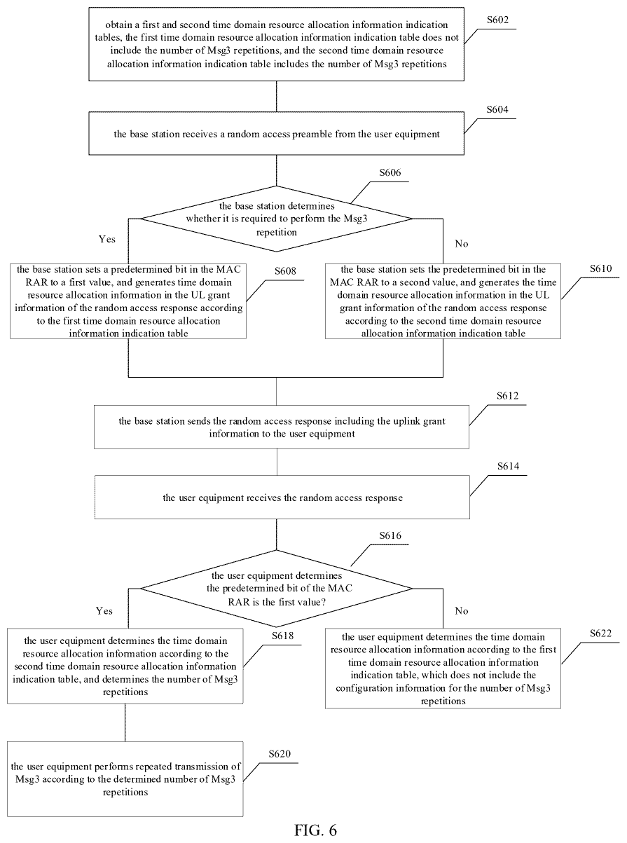

In an embodiment, the base station explicitly determines whether to use the first time domain resource allocation information indication table or the second time domain resource allocation information indication table to generate the content of the time domain resource allocation field in the UL grant information in the random access response: the base station indicates, through 1 bit, whether to use the new (second) time domain resource allocation information indication table, and this 1 bit can be a reserved bit in the RAR. A specific example is shown in FIG. 6 below.

FIG. 6 shows a data transmission method in a random access procedure according to still another embodiment of the present disclosure.

As shown in FIG. 6, in S602, the base station obtains a first time domain resource allocation information indication table and a second time domain resource allocation information indication table, the first time domain resource allocation information indication table does not include the number of Msg3 repetitions, and the second time domain resource allocation information indication table includes the number of Msg3 repetitions.

In S604, the base station receives a random access preamble from the user equipment.

In S606, the base station determines whether it is required to perform the Msg3 repetition. If so, it continues to S608; otherwise, it continues to S610.

In S608, the base station sets a predetermined bit in the RAR to a first value, and the base station generates a random access response including uplink grant information, time domain resource allocation information in the UL grant information of the random access response is generated according to the second time domain resource allocation information indication table, and the time domain resource allocation information includes the configuration information for the number of Msg3 repetitions.

In S610, the base station sets the predetermined bit in the RAR to a second value, and the base station generates the random access response including the uplink grant information, the time domain resource allocation information is generated according to the first time domain resource allocation information indication table, and the time domain resource allocation information does not include the configuration information for the number of Msg3 repetitions.

In S612, the base station transmits the random access response including the uplink grant information to the user equipment.

In S614, the user equipment receives the random access response.

In S616, the user equipment determines whether the predetermined bit of the RAR is the first value. If so, it continues to S618; otherwise, it continues to S622.

In S618, the user equipment determines the time domain resource allocation information according to the second time domain resource allocation information indication table, and determines the number of Msg3 repetitions.

In S620, the user equipment performs Msg3 repetition according to the determined number of Msg3 repetitions, and performs subsequent processing.

In S622, the user equipment determines the time domain resource allocation information according to the first time domain resource allocation information indication table, and the time domain resource allocation information does not include the configuration information for the number of Msg3 repetitions, and performs subsequent processing.

In the above embodiments, the first value can be 1 and the second value can be 0; or conversely, the first value can be 0 and the second value can be 1.

In the above embodiments, the base station explicitly determines whether to use the first time domain resource allocation information indication table or the second time domain resource allocation information indication table to generate the content of the time domain resource allocation field in the UL grant information, and perform different processing, thereby improving flexibility and resource utilization.

A MCS (Modulation and Coding scheme) field in the RAR UL grant information includes four bits to indicate modulation and coding information for the UE's uplink transmission, indicating the first 16 rows of a MCS index table. In some embodiments, the MCS field in the RAR UL grant information indicates the configuration information for the number of Msg3 repetitions.

For the UE requiring enhanced coverage, a modulation and coding order is generally low, a high modulation and coding order is not needed, and overly fine modulation and coding indication is not required. In some embodiments, the MCS field can be split into two parts: the first part contains 2 or 3 bits for indicating the original modulation and coding information, and the second part contains the remaining 2 bits or 1 bit for indicating the number of Msg3 repetitions.

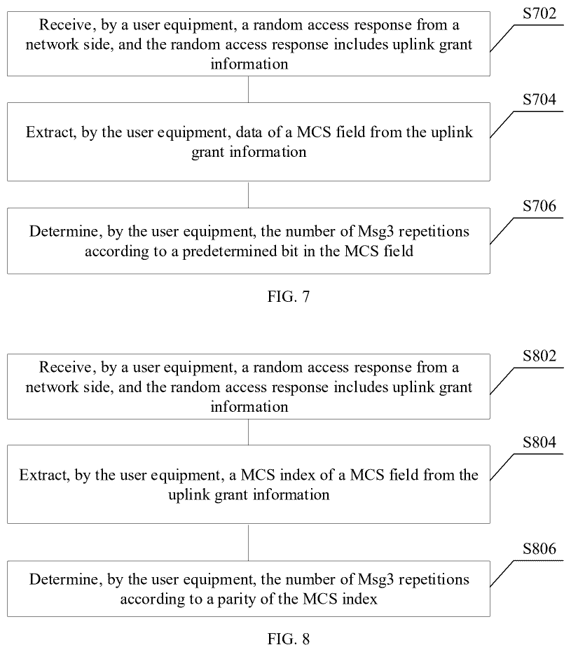

FIG. 7 shows a data transmission method in a random access procedure according to still another embodiment of the present disclosure.

As shown in FIG. 7, in S702, the user equipment receives a random access response from the network side, and the random access response includes uplink grant information.

In S704, the user equipment extracts or determines data of a MCS field from the uplink grant information.

In S706, the user equipment determines the number of Msg3 repetitions according to a predetermined bit in the MCS field.

For example, it is assumed that bit values of the MCS are 1101, which originally represents the modulation and coding information indicated by index “13”. Taking it as split into two 2-bit values (i.e., 11|01) as an example, the modulation and coding information is now indicated by “11”, that is, it represents the modulation and coding information indicated by index “3”; and the number of Msg3 repetitions is indicated by “01”, representing the second of four configurations for the number of Msg3 repetitions. Taking the repetition configurations for Msg3 as {1,2,4,8} as example, then the indicated number of Msg3 repetitions in this case is 2. It should be noted that the split modulation and coding information indication is not limited to using only the first few rows of the corresponding MCS table. Some indices can be first selected from the original 16 rows, and then one index is selected from these rows for indication. Taking the previous example as an example for illustration, index {1,3,5,7} in the table is for example selected, and in this case, “11” indicates the modulation and coding information indicated by index “5” in the table.

In some embodiments, the parity of the MCS index is used to indicate different numbers of Msg3 repetitions. For example, an even index {0, 2, 4, . . . , 14} implicitly indicates the first number of Msg3 repetitions, and an odd index {1, 3, 5, . . . , 15} implicitly indicates the second number of Msg3 repetitions. Considering that the number of data bits transmitted in the initial transmission of Msg3 is small, using the adjacent MCS will not have much impact on the transmission performance. For example, if the index originally indicated by the MCS is 5 before the use of this solution, but now it is desired to use the first number of Msg3 repetitions, and the even index is required for indication, then the base station needs to adjust the index indicated by the MCS to 4 or 6.

FIG. 8 shows a data transmission method in a random access procedure according to still another embodiment of the present disclosure.

As shown in FIG. 8, in S802, the user equipment receives a random access response from the network side, and the random access response includes uplink grant information.

In S804, the user equipment extracts or determines a MCS index of a MCS field from the uplink grant information.

In S806, the user equipment determines the number of Msg3 repetitions according to a parity of the MCS index.

It should be noted that, for the embodiments shown in FIGS. 7 and 8, the base station can implicitly or explicitly determine whether to generate the content in the MCS field according to the first manner or the second manner, in conjunction with the embodiments in FIGS. 5 and 6. After receiving the corresponding MCS indication, the user equipment parses the data according to the corresponding manner. In an embodiment, when a first predetermined condition is met, the content in the field of the uplink grant information is parsed according to a first manner, and the content in this field does not include the configuration information for the number of Msg3 repetitions, and when a second predetermined condition is met, the content in the field of the uplink grant information is parsed according to a second manner, and the content in this field includes the configuration information for the number of Msg3 repetitions. The first predetermined condition may refer to the implicit or explicit determination condition included in FIG. 5 or 6. The first manner may refer to parsing or processing according to the original manner (i.e., according to the field in the uplink grant information not including the configuration information for the number of Msg3 repetitions), while the second manner refers to parsing according to a manner in which the configuration information for the number of Msg3 repetitions is included in the solution of the present disclosure.

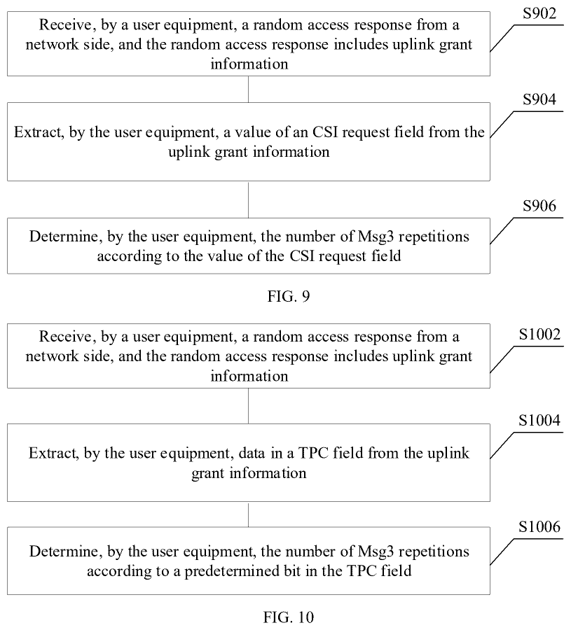

In an embodiment, the configuration information for the number of Msg3 repetitions is indicated through a Channel State Information (CSI) request field in the RAR UL grant information. The CSI request field contains one bit and is currently reserved and unused. This field can be used to configure the Msg3 repetition. For example, bit “0” indicates the first number of Msg3 repetitions, and bit “1” indicates the second number of repetitions. In the following, FIG. 9 shows a specific embodiment.

FIG. 9 shows a data transmission method in a random access procedure according to still another embodiment of the present disclosure.

As shown in FIG. 9, in S902, the user equipment receives a random access response from the network side, and the random access response includes uplink grant information.

In S904, the user equipment extracts or determines a value of an CSI field from the uplink grant information.

In S906, the user equipment determines the number of Msg3 repetitions according to the value of the CSI request field.

In the above embodiments, using the CSI request field to indicate the configuration information for the number of Msg3 repetitions has a relatively small impact. For example, if the CSI is specified to be used directly, it is not necessary to explicitly or implicitly indicate whether to use the CSI request field.

In some embodiments, the configuration information for the number of Msg3 repetitions is indicated through a Transmission Power Control (TPC) field in the RAR UL grant information.

The TPC field includes three bits to indicate a transmission power parameter of Msg3, as shown in the table below.

TABLE 4

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

For the UE with limited Msg3 coverage, full-power transmission is generally used, eliminating the need for the fine TPC control. Therefore, the TPC can be split into two parts: the first part indicates power control information, and the second part indicates the number of Msg3 repetitions. Specifically, there are three cases: 0|3, 1|2, and 2|1, where “0|3” indicates no power control information is indicated, defaulting to full power, and three bits are used to indicate the number of Msg3 repetitions, “1|2” indicates that 1 bit is used to indicate power control information, indicating two rows in the power control indication table, and 2 bits are used to indicate the number of Msg3 repetitions, and so on.

FIG. 10 shows a data transmission method in a random access procedure according to still another embodiment of the present disclosure.

As shown in FIG. 10, in S1002, the user equipment receives a random access response from the network side, and the random access response includes uplink grant information.

In S1004, the user equipment extracts or determines data in a TPC field from the uplink grant information.

In S1006, the user equipment determines the number of Msg3 repetitions according to a predetermined bit in the TPC field.

In some embodiments, bits from a plurality of fields in the uplink grant information are used to jointly indicate the number of Msg3 repetitions. For example, assuming that 3 bits are needed to indicate the number of Msg3 repetitions, the first bit is configured in the time domain resource allocation information, and the second and third bits are configured in the MCS field; or the first and second bits are configured in the time domain resource allocation information, and the third bit is configured in the MCS field. Similarly, all the aforementioned schemes can be combined to indicate the number of Msg3 repetitions. By using the combined indication manner, the requirement for the indication bit used in each field can be reduced, thus providing greater flexibility and freedom.

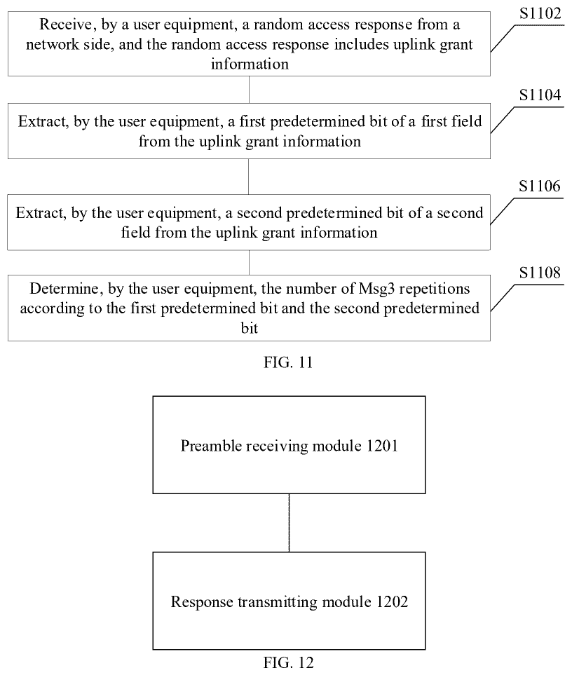

FIG. 11 shows a data transmission method in a random access procedure according to still another embodiment of the present disclosure.

As shown in FIG. 11, in S1102, the user equipment receives a random access response from the network side, and the random access response includes uplink grant information.

In S1104, the user equipment extracts or determines a first predetermined bit of a first field from the uplink grant information, and the first predetermined bit can include one or more bits.

In S1106, the user equipment extracts or determines a second predetermined bit of a second field from the uplink grant information, and the second predetermined bit can include one or more bits.

In S1108, the user equipment determines the number of Msg3 repetitions according to the first predetermined bit and the second predetermined bit. The user equipment can determine the number of Msg3 repetitions according to the value of the combination of the first predetermined bit and the second predetermined bit.

FIG. 12 shows a schematic structural diagram of a base station according to the present disclosure. As shown in FIG. 12, the base station includes: a preamble receiving module 1201, configured to receive a random access preamble transmitted by the UE; and

a response transmitting module 1202, configured to transmit a random access response (RAR) to the UE, and the RAR includes uplink (UL) grant information;

the UL grant information includes configuration information for the number of Msg3 repetitions, so that the number of Msg3 repetitions is determined by the user equipment according to the configuration information for the number of Msg3 repetitions.

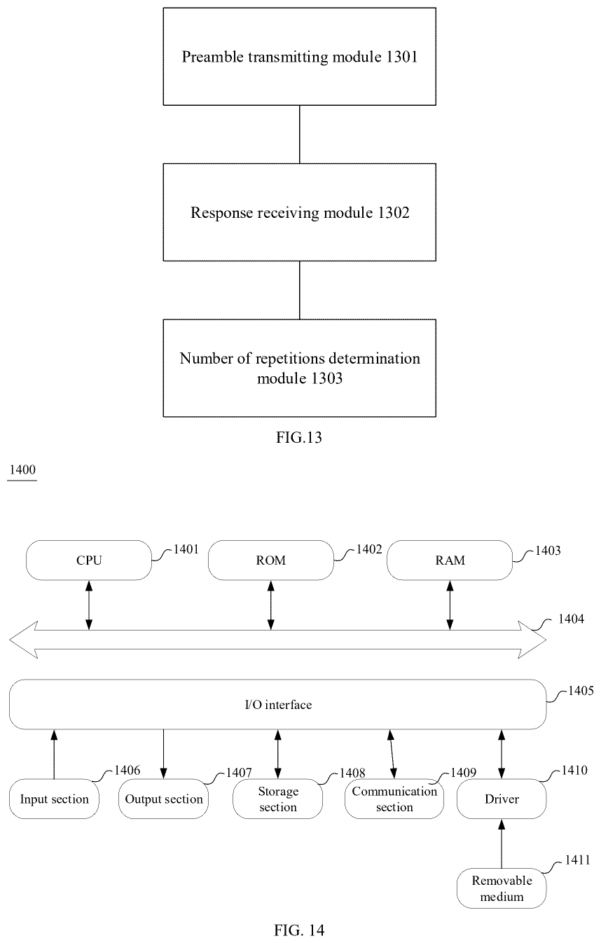

FIG. 13 shows a schematic structural diagram of a user equipment according to the present disclosure. As shown in FIG. 13, the user equipment includes: a preamble transmitting module 1301, configured to transmit a random access preamble; a response receiving module 1302, configured to receive a random access response (RAR) from a network side, the RAR includes uplink (UL) grant information, and the UL grant information includes configuration information for the number of Msg3 repetitions; and a number of repetitions determination module 1303, configured to determine the number of Msg3 repetitions according to the configuration information for the number of Msg3 repetitions in the UL grant information in the RAR.

For the specific implementation of each module in the apparatus provided in embodiments of the present disclosure, reference can be made to the content of the above method, which will not be repeated here.

FIG. 14 shows a schematic structural diagram of an electronic device according to an embodiment of the present disclosure. It should be noted that the device 1400 shown in FIG. 14 only takes a computer system as an example, and should not impose any limitations on the functionality and scope of use of the embodiments of the present disclosure.

As shown in FIG. 14, the device 1400 includes a central processing unit (CPU) 1401 that may perform various appropriate actions and processes according to a program stored in a read only memory (ROM) 1402 or a program loaded from a storage section 1408 into a random access memory (RAM) 1403. In RAM 1403, various programs and data required for the device 1400 operations are also stored. CPU 1401, ROM 1402, and RAM 1403 are connected to each other through a bus 1404. An input/output (I/O) interface 1405 is also connected to the bus 1404.

The following components are connected to the I/O interface 1405: an input section 1406 including a keyboard, a mouse, and the like, an output section 1407 including a cathode ray tube (CRT), a liquid crystal display (LCD) and the like as well as a speaker, and the like, a storage section 1408 including a hard disk, and the like, and a communication section 1409 including a network interface card such as a LAN card, a modem, and the like. The communication section 1409 performs communication processing via a network such as the Internet. A driver 1410 is also connected to I/O interface 1405 as required. A removable medium 1411, such as a magnetic disk, an optical disk, a magneto-optical disk, a semiconductor memory, and the like, is installed on the driver 1410 as required, such that a computer program read from the removable medium 1411 is loaded into the storage section 1408 as required.

Specifically, according to an embodiment of the present disclosure, process described above with reference to a flowchart may be implemented as a computer software program. For example, embodiments of the present disclosure include a computer program product including a computer program carried on a computer-readable medium, and the computer program including program code for executing the method shown in the flowchart. In such an embodiment, the computer program may be downloaded and installed from the network through the communication section 1409, and/or installed from the removable medium 1411. When the computer program is executed by the central processing unit (CPU) 1401, the above functions defined in the system of the present disclosure are executed.

It should be noted that the computer-readable medium shown in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, device, or apparatus, or any combination thereof. More specific examples of computer readable storage media may include, but are not limited to: electrical connection with one or a plurality of wires, portable disk, hard disk, random access memory (RAM), read-only memory (ROM), erasable programmable read-only memory (EPROM or flash memory), optical fiber, portable compact disc read-only memory (CD-ROM), optical storage apparatus, magnetic storage apparatus, or any suitable combination thereof. In the present disclosure, a computer-readable storage medium may be any tangible medium containing or storing a program that may be used by or in combination with an instruction execution system, device, or apparatus. In the present disclosure, the computer-readable signal medium may include a data signal in baseband or propagated as part of a carrier wave, which carries readable program codes. Such a propagated data signal may have many forms, including but not limited to electromagnetic signals, optical signals, or any suitable combination of the above. The computer-readable signal medium may also be any computer-readable storage medium other than a computer-readable storage medium, and the computer-readable medium may send, propagate, or transmit a program that is used by an instruction execution system, device, or apparatus, or that is used in combination with an instruction execution system, device, or apparatus. The program code contained on the computer-readable medium may be transmitted by any suitable medium, including but not limited to: wireless, wire, optical cable, RF, etc., or any suitable combination of the above.

The flowcharts and block diagram in the accompanying drawings illustrate the possible architectures, functions, and operations of systems, methods, and computer program products according to various embodiments of the present disclosure. In this regard, each block in a flowchart or block diagram may represent a module, program segment, or a part of code that contains one or more executable instructions for implementing a specified logic function. It should also be noted that in some alternative implementations, functions indicated in the block may also occur in a different sequence than those indicated in the drawings. For example, two contiguous blocks may actually be executed in substantially parallel, or be executed in reverse sequence sometimes, depending on the function involved. It should also be noted that each block in the block diagram or flowchart and the combination of the blocks in the block diagram or flow chart may be implemented by a dedicated hardware based system that performs a specified function or operation, or by a combination of dedicated hardware and computer instructions.

The involved modules described in embodiments of the present disclosure may be implemented by software or hardware. The described modules may also be provided in a processor, which may be described, for example, as: a processor including a data acquisition module, a data preprocessing module, a recurrent network module, a convolutional network module, a data integration module, and a state classification module. The names of these modules do not necessarily limit the module itself; for example, a data acquisition module may also be described as “a module that acquires initial data from a connected server”.

In another aspect, the present disclosure further provides a computer-readable medium, which may be included in the device described in the above embodiments; or may exist independently and not assembled into the device. The computer-readable medium stores computer-executable instructions that, when executed by a processor, implement any of the methods described above.

Example embodiments of the present disclosure are specifically illustrated and described above. It is to be understood that the present disclosure is not limited to the detailed structure, arrangements, or implementations described herein; on the contrary, the present disclosure is intended to cover various modifications and equivalent arrangements included within the spirit and scope of the appended claims.

1-33. (canceled)

34. A data transmission method in a random access procedure, comprising:
receiving a random access preamble transmitted by a user equipment; and
transmitting a random access response to the user equipment, wherein the random access response comprises uplink grant information;
wherein when the random access preamble is used to request Msg3 repetition, a modulation and coding scheme (MCS) field in the uplink grant information comprises configuration information for the number of Msg3 repetitions, so that the number of Msg3 repetitions is determined by the user equipment according to the modulation and coding scheme field.

35. The data transmission method according to claim 34, wherein one or more predetermined bits in the modulation and coding scheme field of the uplink grant information comprise the configuration information for the number of Msg3 repetitions.

36. The data transmission method according to claim 34, wherein different numbers of Msg3 repetitions are indicated according to a parity of a modulation and coding scheme index represented by the modulation and coding scheme field in the uplink grant information.

37. The data transmission method according to claim 34, further comprising:
when the first predetermined condition is met, interpreting a content in a field of the uplink grant information in a first manner as not comprising the configuration information for the number of Msg3 repetitions; and
when the second predetermined condition is met, interpreting the content in the field of the uplink grant information in a second manner as comprising the configuration information for the number of Msg3 repetitions.

38. The data transmission method according to claim 37, wherein the first predetermined condition is that the user equipment does not request Msg3 repetition; and the second predetermined condition is that the user equipment requests the Msg3 repetition.

39. The data transmission method according to claim 37, wherein the first predetermined condition is that a predetermined bit in the random access response is a first value, and the second predetermined condition is that the predetermined bit in the random access response is a second value.

40. A data transmission method in a random access procedure, comprising:
transmitting, by a user equipment (UE), a random access preamble;
receiving, by the user equipment, a random access response (RAR) from a network side, the random access response comprises uplink grant information, wherein when the random access preamble is used to request Msg3 repetition, a modulation and coding scheme field (MCS) in the uplink grant information comprises configuration information for the number of Msg3 repetitions; and
determining, by the user equipment, the number of Msg3 repetitions according to the modulation and coding scheme field.

41. The data transmission method according to claim 40, wherein one or more predetermined bits in the modulation and coding scheme field of the uplink grant information comprise the configuration information for the number of Msg3 repetitions.

42. The data transmission method according to claim 40, wherein different numbers of Msg3 repetitions are indicated according to a parity of a modulation and coding scheme index represented by the modulation and coding scheme field in the uplink grant information.

43. The data transmission method according to claim 40, further comprising:
when the first predetermined condition is met, interpreting a content in a field of the uplink grant information in a first manner as not comprising the configuration information for the number of Msg3 repetitions; and
when the second predetermined condition is met, interpreting the content in the field of the uplink grant information in a second manner as comprising the configuration information for the number of Msg3 repetitions.

44. The data transmission method according to claim 43, wherein the first predetermined condition is that the user equipment does not request Msg3 repetition or the user equipment does not support the Msg3 repetition; and
the second predetermined condition is that the user equipment requests the Msg3 repetition.

45. The data transmission method according to claim 43, wherein the first predetermined condition is that a predetermined bit in the random access response is a first value, and the second predetermined condition is that the predetermined bit in the random access response is a second value.

46. A terminal, comprising:
a preamble transmitting module, configured to transmit a random access preamble;
a response receiving module, configured to receive a random access response from a network side, the random access response comprises uplink grant information, wherein when the random access preamble is used to request Msg3 repetition, a modulation and coding scheme field (MCS) in the uplink grant information comprises configuration information for the number of Msg3 repetitions; and
a number of repetitions determination module, configured to determine the number of Msg3 repetitions according to the modulation and coding scheme field.

47. A device, comprising: a memory, a processor, and executable instructions stored in the memory and executable in the processor, wherein the processor, when executing the executable instructions, implements the method according to claim 34.

48. A computer-readable storage medium having stored thereon computer-executable instructions that, when executed by a processor, implement the method according to claim 34.
